(19) United States
(12) Patent Application Publication
(10) Pub. No.: US 2026/0168620 A1
(43) Pub. Date: Jun. 18, 2026

(54) PRESSURE VESSEL

(71) Applicants: HYUNDAI MOTOR COMPANY, Seoul (KR); KIA CORPORATION, Seoul (KR)

(72) Inventor: Chan Jin Kim, Hwaseong-si (KR)

(73) Assignees: HYUNDAI MOTOR COMPANY, Seoul (KR); KIA CORPORATION, Seoul (KR)

(21) Appl. No.: 19/255,334

(22) Filed: Jun. 30, 2025

(30) Foreign Application Priority Data
Dec. 17, 2024 (KR) 10-2024-0189167

(51) Int. Cl. F17C 1/16; F17C 13/04

(52) U.S. Cl. CPC F17C 1/16; F17C 13/04; F17C 2201/0109; F17C 2203/0604; F17C 2203/0619; F17C 2203/067; F17C 2205/0323; F17C 2221/012; F17C 2221/033; F17C 2221/035

(57) ABSTRACT

A pressure vessel includes: a nozzle coupled to a valve; a liner including a cylinder part, dome parts, and skirt parts formed between the cylinder part and the dome parts; and a composite material layer being wound around an outer circumference of the liner. The valve includes: a first area formed on an outer surface of the valve. The first area is coupled to an inner surface of the liner and having a stepped surface; and a second area formed on the outer surface of the valve and extending upward from the stepped surface. The nozzle includes a third area formed on an inner surface of the nozzle. The third area is in contact with the second area of the valve, and the liner includes a fourth area formed on the inner surface of the liner. The fourth area includes a stepped surface in contact with the first area.

### CROSS-REFERENCE TO RELATED APPLICATION

This application claims the benefit of and priority to Korean Patent Application No. 10-2024-0189167, filed in the Korean Intellectual Property Office on Dec. 17, 2024, the entire contents of which are incorporated herein by reference.

### TECHNICAL FIELD

The present disclosure relates to a pressure vessel having an excellent airtight performance.

### BACKGROUND

In general, hydrogen electric vehicles generate their own electricity through a chemical reaction between hydrogen and oxygen and drive motors.

More specifically, a hydrogen electric vehicle includes a hydrogen tank, in which hydrogen (H2) is stored, a fuel cell stack that generates electricity through oxidation-reduction reactions between hydrogen and oxygen (O2), various devices for draining generated water, a battery that stores electricity produced in the fuel cell stack, a controller that converts and controls the produced electricity, a motor that generates a driving force, and the like.

Four types of pressure vessels may be used as a hydrogen tank for a hydrogen electric vehicle.

Because a high-pressure gaseous fuel (hydrogen gas) has to be stored in the pressure vessel, structural robustness is required. Pressure vessels for storing high-pressure hydrogen gas are classified into four types: type I, type II, type III, and type IV depending on materials used and a composite material reinforcement method.

Among them, a type IV pressure vessel includes a nozzle of a metal material (i.e., a metal nozzle), a liner of a nonmetal material (i.e., a non-metal liner), and a composite material formed by winding carbon fiber or glass fiber around the liner in both the circumferential and longitudinal directions.

The type IV pressure vessel is a container that is advantageous for weight reduction and may reduce costs by simplifying handling and manufacturing processes.

However, a nonmetallic liner undergoes a phenomenon in which the hydrogen gas permeates outward under high pressure, thereby exerting pressure on the nozzle in an outward direction. Accordingly, the pressure vessel may be installed in a hydrogen electric vehicle only after passing strict legal and quality standards. However, dynamic situations, such as rapid charging and exhaust vibrations, beyond the normal permeation state also have to be considered in an actual operation stage.

Considering the dynamic situation, the biggest problem is that hydrogen gas permeating through a nonmetallic liner cannot be discharged to the outside of the pressure vessel, but instead accumulates at an interface between the composite material and the liner. The high-concentration hydrogen gas, in the form of a leak and retained along the interface, may be exposed during rapid exhaust or vibration and could ignite.

### SUMMARY

The present disclosure has been made to solve the above-mentioned problems occurring in the prior art while advantages achieved by the prior art are maintained intact.

An aspect of the present disclosure provides a pressure vessel having an improved airtight performance.

Objects of the present disclosure are not limited to the above-mentioned object, and other objects and advantages of the present disclosure that is not mentioned should be understood from the following description, and it should be apparently understood from embodiments of the present disclosure. In addition, it should be easily understood that the objects and advantages of the present disclosure are realized by means and combinations described in the appended claims.

According to an aspect of the present disclosure, a pressure vessel may include: a nozzle configured to be coupled to a valve, and a liner formed on an inner peripheral surface of the nozzle. The liner includes: a cylinder part; dome parts formed at opposite ends of the cylinder part; and skirt parts formed between the cylinder part and the dome parts. The pressure vessel further includes a composite material layer including a hoop layer and a helical layer. The hoop layer and the helical layer are would around an outer circumference of the liner. The valve may include: a first area formed on an outer peripheral surface of the valve, wherein the first area is coupled to an inner peripheral surface of the liner and including a stepped surface, and a second area formed on the outer peripheral surface of the valve and extending upward from the stepped surface along a lengthwise direction of the valve. The nozzle may include a third area formed on an inner peripheral surface of the nozzle, wherein the third area is in contact with the second area of the valve. The liner may include a fourth area formed on an inner peripheral surface of the liner, wherein the fourth area includes a stepped surface in contact with the first area of the valve. In an embodiment, a first seal part is provided between the stepped surface of the first area of the valve and the stepped surface of the fourth area of the liner.

According to an embodiment of the present disclosure, a screw thread may be formed on the second area of the valve, and a corresponding screw thread may be formed on the third area of the nozzle.

According to an embodiment of the present disclosure, the stepped surface of the first area of the valve may expand in diameter toward an inlet of the nozzle.

According to an embodiment of the present disclosure, at least one stepped surface of the outer peripheral surface of the first area of the valve and at least one stepped surface of the inner peripheral surface of the liner may be formed.

According to an embodiment of the present disclosure, the first seal part may include a first sealing ring mounted on a step formed on the stepped surface of the first area of the valve to remain in close contact with the stepped surface of the fourth area of the liner, and a second sealing ring inserted into an inner groove formed on the stepped surface of the first area of the valve to remain in close contact with the stepped surface of the fourth area of the liner.

According to an embodiment of the present disclosure, the first seal part may include a backup ring that exerts a compressive force on a side of the first sealing ring and the second sealing ring.

According to an embodiment of the present disclosure, the pressure vessel may further include a second seal part press-fitted into an installation groove installed along a circumference of the skirt part on an interface between the nozzle and the composite material layer.

According to an embodiment of the present disclosure, the composite material layer wound around the second seal part may compress the second seal part to half or less of a width of the second seal part during initial winding.

According to an embodiment of the present disclosure, a width of the second seal part may be formed to be three times or more than a height thereof.

According to an embodiment of the present disclosure, an annular shape may be formed along an outer peripheral surface of an inlet of the nozzle, and the pressure vessel further may include a third seal part installed in a spacing space between a lower end of the valve coupled to the nozzle and an upper end of the composite material layer.

According to an embodiment of the present disclosure, the third seal part is any one of an O-ring or an adhesive.

### BRIEF DESCRIPTION OF THE DRAWINGS

The above and other objects, features and advantages of the present disclosure should be more apparent from the following detailed description taken in conjunction with the accompanying drawings:

FIG. 1 is a cutaway perspective view of a pressure vessel according to an embodiment of the present disclosure, in which a portion of the pressure vessel is cut away;

FIG. 2 is an enlarged view illustrating portion “A” of FIG. 1;

FIG. 3 is a cross-sectional view illustrating a pressure vessel according to an embodiment of the present disclosure;

FIG. 4 is an enlarged view illustrating portion “B” of FIG. 3;

FIG. 5 is a cross-sectional view illustrating a first seal part of a pressure vessel according to another embodiment of the present disclosure;

FIG. 6 is a perspective view illustrating a second seal part of a pressure vessel according to an embodiment of the present disclosure;

FIG. 7 is a view illustrating a state, in which a composite material layer is initially wound on a second seal part of FIG. 6;

FIG. 8 is a cross-sectional view illustrating a state, in which a third seal part is installed in a pressure vessel according to an embodiment of the present disclosure; and

FIG. 9 is a view illustrating a state in which a third seal part is installed in a pressure vessel according to another embodiment of the present disclosure;

FIG. 10 is a perspective view illustrating a composite material layer according to an embodiment of the present disclosure.

The drawings described herein are for illustration purposes only and are not intended to limit the scope of the present disclosure in any way.

### DETAILED DESCRIPTION

Hereinafter, some embodiments of the present disclosure are described in detail with reference to the accompanying drawings. In adding reference numerals to the components of the drawings, it should be noted that the same components have the same numerals as possible even when they are illustrated on different drawings. In describing embodiments of the present disclosure, detailed descriptions associated with well-known functions or configurations have been omitted if they may make subject matters of the present disclosure unnecessarily obscure.

Furthermore, in describing components of embodiments of the present disclosure, the terms first, second, A, B, (a), (b), and the like may be used herein. These terms are only used to distinguish one component from another component, but do not limit the corresponding components irrespective of the nature, order, or priority of the corresponding components. When it is described that a certain component is “connected to”, “coupled to” or “electrically connected to” a second component, it should be understood that the component may be directly connected or electrically connected to the second component, but a third component may be “connected”, “coupled” or “electrically connected” between the components.

When a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function.

Hereinafter, a pressure vessel 100 according to an embodiment of the present disclosure is described in detail with reference to the accompanying drawings.

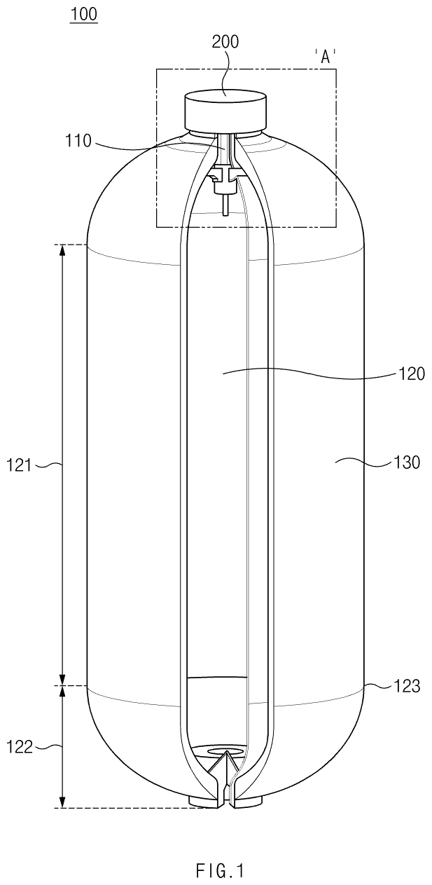

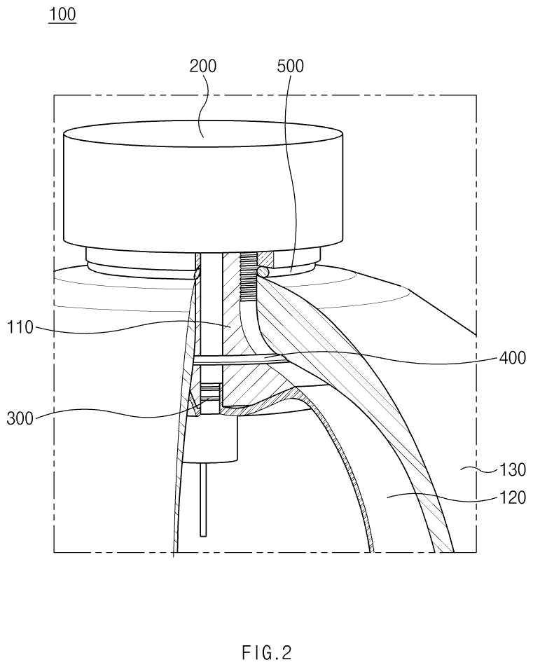

FIG. 1 is a cutaway perspective view of a pressure vessel 100 according to an embodiment of the present disclosure, in which a portion of the pressure vessel is cut away, and FIG. 1 illustrates components of the pressure vessel 100. Furthermore, FIG. 2 is an enlarged view illustrating portion “A” of FIG. 1.

The pressure vessel 100 is a container that may compress various fluids including liquefied petroleum gas (LPG), compressed natural gas (CNG), hard hydrocarbons (methane, propane, butane), and hydrogen gas and safely store them, and is currently applied to hydrogen electric vehicles.

In an embodiment, referring to FIGS. 1-2, the pressure vessel 100 may include a nozzle 110, a liner 120, and a composite material layer 130.

The nozzle 110 may be a main inlet that extends outward from one side of the pressure vessel 100 and compresses and injects hydrogen gas. As the nozzle 110 extends in an outward direction of the pressure vessel 100, an impact that may be applied to the composite material layer 130 due to fall of the pressure vessel 100 may be minimized.

A valve 200 or a similar component located in the vehicle may be coupled to the nozzle 110, and may be formed of the same metal material to provide a secure connection with the valve 200 or other metal components. The valve 200 may be made of a metal material, such as aluminum (Al6061T6) or stainless steel (SUS316L).

The liner 120 may include a cylinder part 121 that is formed along an axial direction of the pressure vessel 100 and two dome parts 122 that are formed at opposite ends of the cylinder part 121, respectively. Skirt parts 123 may be provided between the cylinder part 121 and the dome parts 122.

The cylinder part 121 has a cylindrical shape and forms the liner 120 as well as the body of the pressure vessel 100 including the liner 120. The dome parts 122 may be formed at opposite ends of the cylinder part 121 in a hemispherical shape.

The cylinder part 121 may be formed in a linear shape having no curvature along an axial direction of the pressure vessel 100. The cylinder part 121 may have a shape having a curvature along a circumferential direction of the pressure vessel 100. Meanwhile, the dome part 122 may have a shape having a curvature in both the axial direction and the circumferential direction of the pressure vessel 100.

The material of the liner 120 may be variously changed according to required conditions and design specifications, and the present disclosure is neither limited nor restricted by the material of the liner 120. However, the liner 120 may be formed of a nonmetallic material, such as high-density plastic having an excellent restoring force and an excellent fatigue.

The liner 120 is capable of storing hydrogen gas compressed at a high pressure in its internal space (i.e., inner space), and may be manufactured by methods such as blow molding or rotary molding.

The composite material layer 130 is wound around an outer circumference of the liner 120, and may be made of a fiber-reinforced composite material (filament) including high-strength fibers, such as carbon fibers or glass fibers with high structural strength and rigidity to withstand a high internal pressure of the high-pressure hydrogen gas, and polymer resins, such as epoxy that surrounds high-strength fibers.

The composite material layer 130 serves as a reinforcing layer that resists stress applied to the liner 120, thereby providing structural strength and rigidity to enable the liner 120 to withstand high pressure.

The composite material layer 130 may be formed by a winding band formed of a fiber-reinforced composite material. The winding band, having a specific width, may be applied by winding it around the liner 120 to surround the liner 120.

A winding structure and a winding method for the composite material layer 130 may be variously changed according to required conditions and design specifications, and the present disclosure is neither limited nor restricted by the winding method for the composite material layer 130. For example, the composite material layer 130 may be formed by winding several filaments on an outer surface of the liner 120 in various patterns.

The composite material layer 130 may include a hoop layer 131 and a helical layer 132.

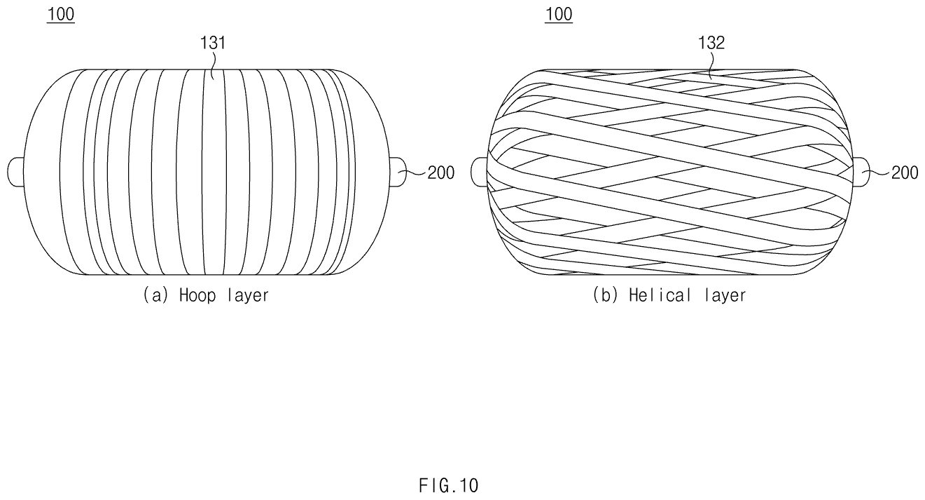

As illustrated in FIG. 10, the hoop layer 131 may be formed by winding a continuous fiber-reinforced composite material on an outer peripheral surface of the cylinder part 121 in an approximately vertical direction with respect to a central axis of the pressure vessel 100. The hoop layer 131 functions to support the stress in a circumferential direction under high pressure.

The helical layer 132 may be formed by continuously winding a continuous fiber-reinforced composite material at an angle with respect to the central axis of the pressure vessel 100, onto the hoop layer 131 and the outer peripheral surface of the dome part 122. The helical layer 132 functions to support stress that acts in the axial direction of the pressure vessel 100. In other words, the hoop layer 131 is wound over the cylinder part 121 of the pressure vessel 100, but not is wound over the dome part 122. On the other hand, the helical layer 132 may be wound over both the cylinder part 121 and the dome part 122 of the pressure vessel 100.

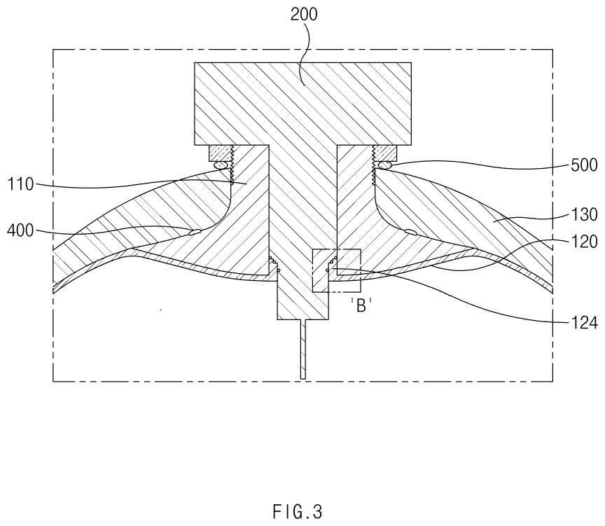

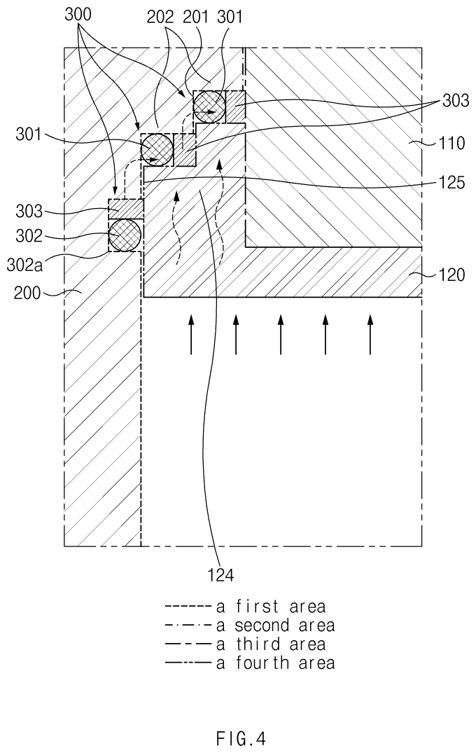

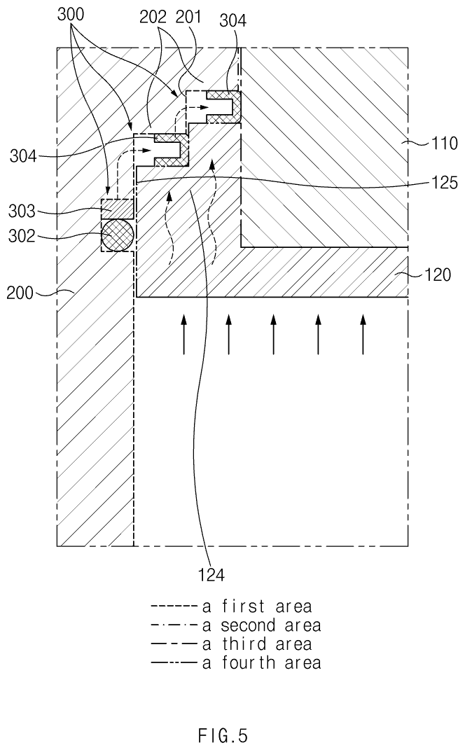

FIG. 3 is a cross-sectional view illustrating a pressure vessel 100 according to an embodiment of the present disclosure, FIG. 4 is an enlarged view illustrating portion “B” of FIG. 3, and FIG. 5 is a cross-sectional view illustrating a first seal part 300 of a pressure vessel 100 according to another embodiment of the present disclosure.

Referring to the accompanying drawing, the pressure vessel 100 in a state, in which the nozzle 110 is closed by the valve 200, may include a first seal part 300.

The first seal part 300 may be located between the valve 200 and the liner 120 that are coupled to the nozzle 110.

The valve 200 may be screw-coupled to the inner peripheral surface of the nozzle 110 along an inner peripheral surface of the liner 120, on which a protrusion 124 that protrudes in a cylindrical shape is formed.

The valve 200 may include a first area having a stepped surface 201 inserted and fixed along an inner peripheral surface of the protrusion 124 is formed on the outer peripheral surface, and a second area that extends in a lengthwise direction thereof toward an upper side of the first area.

In the valve 200, the stepped surface 201 of the outer peripheral surface of the first area may be gradually expanded as it goes toward the inlet of the nozzle 110. In other words, the stepped surface 201 of the first area may gradually expand in diameter as it goes toward the inlet of the nozzle 110.

The nozzle 110 may include a third area, in which an outer peripheral surface of the second area of the valve 200 contacts the inner peripheral surface, and the liner 120 may include a fourth area, in which the stepped surface 125 that contacts an outer peripheral surface of the first area of the valve 200 is formed on the inner peripheral surface.

A plurality of stepped surfaces 201 corresponding to the stepped surfaces 125 of an inner peripheral surface of the liner 120 may be formed on an outer peripheral surface of the first area of the valve 200.

In this case, at least one stepped surface 201 formed on an outer peripheral surface of the first area of the valve 200 and at least one stepped surface 125 of the inner peripheral surface of the liner 120 may be applied.

At least one first seal part 300 for an airtight performance may be installed between the stepped surface 201 of the outer peripheral surface of the first area of the valve 200 and the stepped surface 125 of the inner peripheral surface of the liner 120.

In an embodiment, a screw thread may be formed on the outer peripheral surface of the second area of the valve 200, and a corresponding screw thread may be formed on the inner peripheral surface of the third area of the nozzle 110. In other words, the second area of the valve 200 and the third area of the nozzle 110 may be coupled to each other through a screw fastening method.

The first seal part 300 may maintain airtightness while contacting the stepped surface 125 of the inner peripheral surface of the liner 120 to prevent leakage of the hydrogen gas through the protrusion 124 of the liner 120. In this case, a plurality of stepped surfaces 201 of the valve 200 and a plurality of stepped surfaces 125 of the liner 120 are provided, and thus, airtightness may be additionally maintained on an upper side of the stepped surfaces 125 and 201, which is adjacent to an outer side of the pressure vessel 100, when the hydrogen gas is leaked on a lower side of the stepped surfaces 125 and 201, which is adjacent to an inside of the pressure vessel 100.

The first seal part 300 may include an O-ring and a backup ring that is closely attached to the O-ring.

The first seal part 300 is formed of a rubber material, such as EPDM, EBDM, and VNQ, which may ensure an airtight performance for very small hydrogen gas, and is located in the axial and radial directions with respect to the central axis of the pressure vessel 100 to prevent leakage of the high-pressure hydrogen gas stored inside through a gap between the valve 200 and the liner 120.

The first seal part 300 includes a first sealing ring 301 that is mounted on a step 202 formed on the stepped surface 201 of the outer peripheral surface of the first area of the valve 200 to be maintained closely attached to the stepped surface 201 of the inner peripheral surface of the liner 120, and a second sealing ring 302 that is inserted into an inner groove 302a formed on the stepped surface 201 of the outer peripheral surface of the first area of the valve 200 to be maintained closely attached to the stepped surface 201 of the inner peripheral surface of the liner 120.

The first and second sealing rings 301 and 302 may be formed of O-rings.

The first sealing ring 301 may prevent leakage of hydrogen gas due to expansion of the liner 120 in a radial direction, and the second sealing ring 302 may prevent leakage of hydrogen gas due to expansion of the liner 120 in a vertical direction.

When deformation occurs due to a pressure that is applied to the first sealing ring 301 and the second sealing ring 302 located between the stepped surface 125 of the inner peripheral surface of the liner 120 and the stepped surface 201 of the first area of the valve 200, a backup ring 303 that exerts a compressive force to one side of the first sealing ring 301 and the second sealing ring 302 to prevent this may be installed.

The backup ring 303 is formed of a polyether ether ketone (PEEK) material, and may be used as an auxiliary member for increasing a sealing force of the first sealing ring 301 and the second sealing ring 302 and preventing damage to the first sealing ring 301 and the second sealing ring 302.

Accordingly, the outer peripheral surface of the liner 120 and the first area of the valve 200 may firmly contact each other through a screw fastening method.

When the first seal part 300 in the axial direction is screw-coupled along the liner 120, a metal chip plugging phenomenon of the first seal part 300 that may occur due to strong compression of the first seal part 300 and the nozzle 110 and a lengthwise movement of the nozzle 110 may be prevented because the liner 120 is formed of a non-metallic material.

Because the second sealing ring 302 does not need to be rotated along the liner 120 in a screw fastening manner with the valve 200, initial damage may be prevented.

Here, the first seal part 300 is neither restricted nor limited to the first and second sealing rings 301 and 302 and the backup ring 303, and as illustrated in FIG. 5, a “U” seal 304 that presses a spring having a repulsive elasticity against a Teflon jacket wet surface to maintain a sealing force and implements an excellent sealing performance at a low pressure and a high pressure may be adopted.

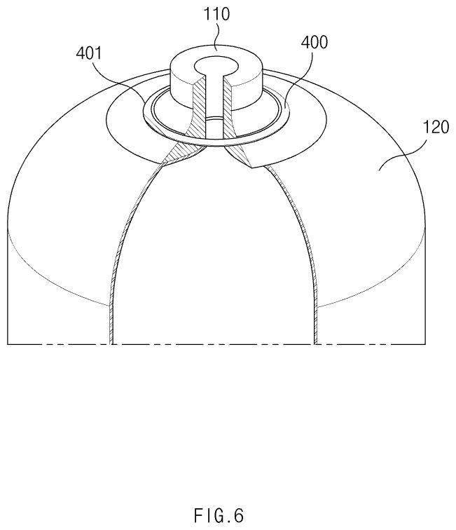

FIG. 6 is a perspective view illustrating a second seal part 400 of a pressure vessel 100 according to an embodiment of the present disclosure.

As illustrated in FIG. 6, the second seal part 400 may prevent the hydrogen gas in the interior of the pressure vessel 100 from being collected on an interface between the liner 120 and the composite material layer 130 in a high pressure state and the staying hydrogen gas from being discharged to the outside along the interface during rapid exhaust or vibration.

The second seal part 400 is located on an interface between the nozzle 110 and the composite material layer 130 so that hydrogen gas may stay, and may be installed along a circumference of the skirt part 123 of the nozzle 110 connected to the liner 120.

An installation groove 401, into which the second seal part 400 may be pressed-fitted, may be formed at a circumference the skirt part 123 of the nozzle 110.

Regardless of a cross-sectional shape of the second seal part 400, the installation groove 401 may have a rectangular shape, or a rectangular shape with rounded corners. Accordingly, when the pressure vessel 100 is repeatedly expanded, separation of the second seal part 400 may be prevented and the stress applied to the nozzle 110 may be reduced.

When the second seal part 400 of the annular shape is press-fitted into the installation groove 401 formed in the skirt part 123 of the nozzle 110, separation and buckling of the second seal part 400 may be prevented, and thus, a contact surface pressure and a compression rate for sealing in an inner pressure situation may be provided.

The second seal part 400 may have a cross-sectional shape, such as an elliptical shape, a geodesic shape, and a quadrangular shape. This cross-sectional shape may be more advantageous because, when the composite material layer 130 is wound, uniform deformation of the second seal part 400 may be implemented, an internal stress applied to the second seal part 400 may be minimized, and an airtight performance may be maximized.

Furthermore, a width (long axis) of the second seal part 400 may be three times or more than a height (short axis) thereof.

As a result, a stable airtight performance may be secured, an airtight contact may be ensured during winding of the composite material layer 130, a slip may be minimized during the winding of the composite material layer 130, and damage to the nozzle 110 may be prevented.

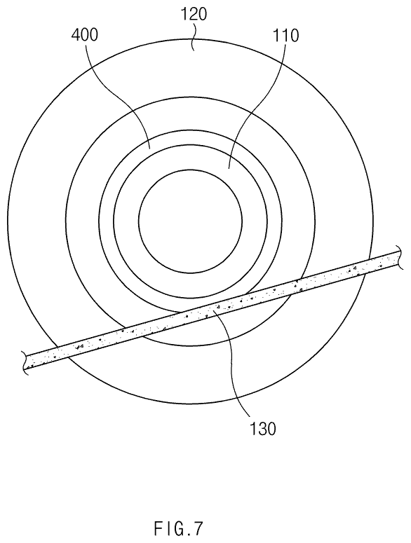

FIG. 7 is a view illustrating a state, in which a composite material layer 130 is initially wound around a second seal part 400 of FIG. 6.

As illustrated in FIG. 7, the composite material layer 130 wound around the second seal part 400 is supposed to compress a half of the width of the second seal part 400 or less during the initial winding.

When the half of the width of the second seal part 400 or more is covered, the composite material layer 130 may not be in airtight contact with the second seal part 400, and a gap may occur to form a passage, through which the hydrogen gas flows.

Accordingly, when the composite material layer 130 is initially wound to compress the second seal part 400 to the half of the width of the second seal part 400 or less, sufficient surface pressure may be generated during subsequent continuous winding of the composite material layer 130. As a result, the composite material layer 130 may be hermetically pressed against the second seal part 400, and by preventing occurrence of a gap, the formation of a passage, through which the hydrogen gas may flow, may be excluded.

In an embodiment, the position of the second seal part 400 is adjusted to correspond to the pattern of the composite material layer 130 and the position of the composite material layer 130 is adjusted to correspond to the position of the second seal part 400.

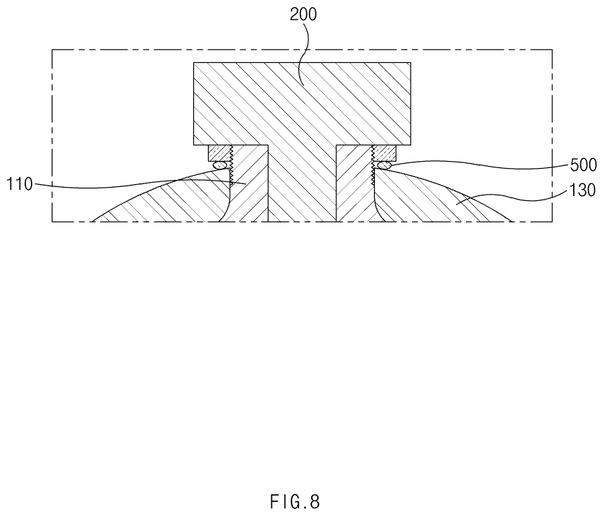

FIG. 8 is a cross-sectional view illustrating a state, in which a third seal part 500 is installed in a pressure vessel 100 according to an embodiment of the present disclosure.

As illustrated in FIG. 8, the valve 200 may be coupled to the nozzle 110 through a screw coupling method.

The third seal part 500 is formed of a rubber material, such as EPDM, EBDM, and VNQ, that may ensure an airtight performance for very small hydrogen gas, and may be an O-ring. The third seal part 500 may be installed in an annular shape along an outer peripheral surface of the inlet of the nozzle 110.

The third seal part 500 may be installed between a lower end of the valve 200 in a coupled state to the nozzle 110 and an upper end of the composite material layer, that is, in a spacing space between the valve 200 in the coupled state to the nozzle 110 and the composite material layer 130.

The third seal part 500 may finally prevent the hydrogen gas in the interior of the pressure vessel 100 from being collected on an interface between the liner 120 and the composite material layer 130 in a high pressure state and the staying hydrogen gas from being discharged to the outside along the interface during rapid exhaust or vibration.

When the third seal part 500 is installed while being exposed to the outer peripheral surface of the inlet of the nozzle 110, it is sufficient as long as it corresponds to lengthwise expansion of the pressure vessel 100, and thus, durability may be improved.

The third seal part 500 has a configuration that is coupled in a post-process sequence on the process, it corresponds to a simple coupling process even when a manufacturing tolerance of the liner 120 or the composite material layer 130 occurs, and thus, a uniform performance may be exhibited.

The third seal part 500 may have a cross-sectional shape, such as an elliptical shape, a geodesic shape, and a quadrangular shape. Because the cross-sectional shape may sufficiently absorb the manufacturing tolerance of the composite material layer 130 when the composite material layer 130 is wound, a uniform compressive deformation of the third seal part 500 may be implemented, and an internal stress applied to the third seal part 500 may be minimized and sealing performance may be maximized.

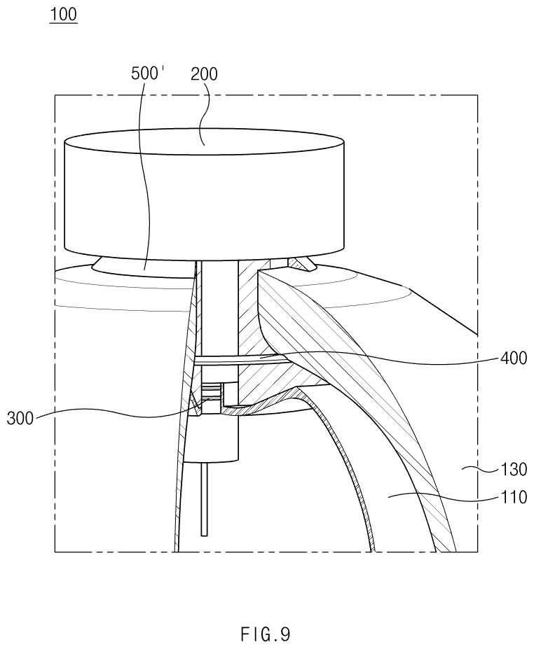

FIG. 9 is a cross-sectional view illustrating a state, in which a third seal part 500 is installed in a pressure vessel 100 according to another embodiment of the present disclosure.

The third seal part 500′ may be an adhesive. The third seal part 500′ may be bonded to both metal and non-metal materials, and may be formed of an acrylic or epoxy material that may maintain sufficient durability and rigidity.

Accordingly, when the valve 200 is coupled to the nozzle 110 while the hydrogen gas is injected into the pressure vessel 100 at a high pressure and stored, the valve 200 contacts and is joined by the third seal part 500, so that an external leakage of the hydrogen gas may be prevented.

When the nozzle 110 with a triple seal structure is applied to the pressure vessel 100 and is airtight-coupled to the valve 200 provided on the body of the hydrogen electric vehicle, the present disclosure may improve durability and airtightness by completely preventing an external leakage of the high-pressure hydrogen gas and preventing an ignition due to the discharge of hydrogen gas.

In addition, the present disclosure may maintain a sufficient airtight performance without the pressure vessel being damaged even when repetitive fatigue loads, such as filling hydrogen gas, are accumulated in the pressure vessel.

According to the pressure vessel according to the present disclosure having the above-described configuration, by providing the plurality of seal parts between the passages to prevent the hydrogen gas leaked through the nozzle in a state, in which the hydrogen gas is injected and stored, and the pressure vessel is closed through the valve, and the hydrogen gas that passes along the interface between the liner and the composite material layer from being discharged to the outside, leakage of the hydrogen gas is effectively suppressed, and a durability and an airtight performance may be maintained even under a high pressure condition.

When the nozzle with a triple seal structure is applied to the pressure vessel and is airtight-coupled to the valve provided on the body of the hydrogen electric vehicle, the present disclosure may completely prevent an external leakage of the high-pressure hydrogen gas and preventing an ignition due to the discharge of hydrogen gas.

In addition, the present disclosure may improve a structural vulnerable disadvantage due to repeated fatigue loads, such as filling of the hydrogen gas.

The above-mentioned description of the present disclosure is intended to be illustrative, and it should be understood by those having ordinary skill in the art that the present disclosure may be embodied in other specific forms without departing from the spirit or essential characteristics thereof. Therefore, the above-described embodiments are examples in all aspects, and should be construed not to be restrictive. The scope of the present disclosure is defined by claims to be described below, and it should be interpreted that the scopes or claims of the present disclosure and all modifications or changed forms derived from the equivalent concept are included in the scopes of the present disclosure.

What is claimed is:

1. A pressure vessel comprising:
a nozzle configured to be coupled to a valve;
a liner formed on an inner peripheral surface of the nozzle and including:
a cylinder part,
dome parts formed at opposite ends of the cylinder part, and
skirt parts formed between the cylinder part and the dome parts; and
a composite material layer including a hoop layer and a helical layer, the hoop layer and the helical layer being wound around an outer circumference of the liner,
wherein the valve includes:
a first area formed on an outer peripheral surface of the valve, wherein the first area is coupled to an inner peripheral surface of the liner and includes a stepped surface, and
a second area formed on the outer peripheral surface of the valve and extending upward from the stepped surface along a lengthwise direction of the valve,
wherein the nozzle includes a third area formed on an inner peripheral surface of the nozzle, wherein the third area is in contact with the second area of the valve,
wherein the liner includes a fourth area formed on the inner peripheral surface of the liner, wherein the fourth area includes a stepped surface in contact with the first area of the valve, and
wherein a first seal part is provided between the stepped surface of the first area of the valve and the stepped surface of the fourth area of the liner.

2. The pressure vessel of claim 1, wherein a screw thread is formed on the second area of the valve, and a corresponding screw thread is formed on the third area of the nozzle.

3. The pressure vessel of claim 1, wherein the stepped surface of the first area of the valve is configured to expand in diameter toward an inlet of the nozzle.

4. The pressure vessel of claim 1, wherein the first seal part includes:
a first sealing ring mounted on a step formed on the stepped surface of the first area of the valve to remain in close contact with the stepped surface of the fourth area of the liner; and
a second sealing ring inserted into an inner groove formed on the stepped surface of the first area of the valve to remain in close contact with the stepped surface of the fourth area of the liner.

5. The pressure vessel of claim 4, wherein the first seal part includes a backup ring configured to exert a compressive force on a side of the first sealing ring and the second sealing ring.

6. The pressure vessel of claim 1, further comprising:
a second seal part press-fitted into an installation groove installed along a circumference of the skirt part on an interface between the nozzle and the composite material layer.

7. The pressure vessel of claim 6, wherein the composite material layer wound around the second seal part is configured to compress the second seal part to half or less of a width of the second seal part during initial winding.

8. The pressure vessel of claim 6, wherein a width of the second seal part is formed to be three times or more than a height thereof.

9. The pressure vessel of claim 1, wherein an annular shape is formed along an outer peripheral surface of an inlet of the nozzle.

10. The pressure vessel of claim 9, further including a third seal part installed in a space between a lower end of the valve coupled to the nozzle and an upper end of the composite material layer.

11. The pressure vessel of claim 10, wherein the third seal part includes at least one of an O-ring or an adhesive.
